(19) United States
(12) Patent Application Publication
(10) Pub. No.: US 2025/0183772 A1
(43) Pub. Date: Jun. 5, 2025

(54) METHOD FOR MANUFACTURING ROTOR

(71) Applicant: TOYOTA BOSHOKU KABUSHIKI KAISHA, Aichi-ken (JP)

(72) Inventors: Keita NAMBA, Nagoya-shi (JP); Yasunori SAKURAI, Hashima-shi (JP); Hiroyuki SAIKI, Toki-shi (JP)

(73) Assignee: TOYOTA BOSHOKU KABUSHIKI KAISHA, Aichi-ken (JP)

(21) Appl. No.: 18/953,829

(22) Filed: Nov. 20, 2024

(30) Foreign Application Priority Data
Nov. 30, 2023 (JP) 2023-202968

(51) Int. Cl. H02K 15/12; H02K 15/03

(52) U.S. Cl. CPC H02K 15/12; H02K 15/03; H02K 2215/00

(57) ABSTRACT

A method for manufacturing a rotor includes controlling a thickness of a rotor core, placing the rotor core on a fixed die or a movable die of a plastic filling device after controlling the thickness of the rotor core, clamping the rotor core by moving the movable die vertically to a clamping position, and filling an insertion hole of the rotor core with a plastic. The clamping of the rotor core includes, when clamping, for the first time, a rotor core of a type different from a rotor core clamped immediately prior, detecting whether the rotor core of the different type is in a clamped state, storing, in a memory, the position of the movable die in the vertical direction at the time when the rotor core is detected to be in the clamped state as the clamping position, and stopping the vertical movement of the movable die.

### CROSS-REFERENCE TO RELATED APPLICATIONS

This application is based upon and claims the benefit of priority from prior Japanese Patent Application No. 2023-202968, filed on Nov. 30, 2023, the entire contents of which are incorporated herein by reference.

### BACKGROUND

### 1. Field

The present disclosure relates to a method for manufacturing a rotor.

### 2. Description of Related Art

A magnet-embedded core is formed by stacking multiple iron core pieces. The core includes magnet insertion holes that extend in a stacking direction of the iron core pieces to receive magnets. A thermoplastic filling device for the magnet-embedded core includes a lower die and an upper die. The core is placed on the lower die. The lower die is configured to be moved vertically. The upper die is configured to press the upper surface of the core in response to the upward movement of the lower die, thereby clamping the core. In this state, in which the core is clamped by the upper die and the lower die, plastic is injected into the magnet insertion holes through a passage in the lower die, thereby fixing the magnets to the core.

Additionally, plastic filling devices may control the movement of a movable die, as described below. Specifically, a plastic filling device detects the clamping position of the movable die in the vertical direction using a detection unit of a controller. The clamping position detected by the detection unit is stored in a storage unit of the controller. Then, the movable die is raised or lowered until the movable die is at the clamping position, so that clamping is performed.

In the manufacturing process of a rotor using such a plastic filling device, there are cases in which the type of core being manufactured is switched to a core with a different thickness from the previously-formed core. In such cases, it is necessary to detect and store the clamping position of the movable die corresponding to the newly switched core. Typically, a master workpiece simulating the new core is used to detect and store the clamping position. However, this approach complicates the rotor manufacturing process, as clamping must be performed using the master workpiece. Additionally, there is the issue of needing to prepare master workpieces, which must be manufactured to high dimensional accuracy, for each type of core.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a rotor is provided. The rotor includes a rotor core, a magnet, and a plastic. The rotor core is formed by stacking multiple iron core pieces and includes an insertion hole extending in a stacking direction of the iron core pieces. The magnet is inserted into the insertion hole. The plastic fills the insertion hole to fix the magnet. The method includes: controlling a thickness of the rotor core such that the thickness of the rotor core is in a specified range that is set for each type of the rotor core; after the controlling the thickness of the rotor core, placing the rotor core on a fixed die or a movable die of a plastic filling device with the magnet inserted into the insertion hole, the movable die being configured to be moved vertically; clamping the rotor core by moving the movable die vertically to a clamping position stored in a memory of control circuitry; and filling the insertion hole with the plastic in a state in which the rotor core is clamped by the fixed die and the movable die. The clamping the rotor core includes: when clamping, for a first time, a rotor core of a type different from a rotor core clamped immediately prior, detecting whether the rotor core of the different type is in a clamped state; storing, in the memory, a position of the movable die in the vertical direction at the time when the rotor core is detected to be in the clamped state as the clamping position; and stopping the vertical movement of the movable die.

Other features and aspects will be apparent from the following detailed description, the drawings, and the claims.

### BRIEF DESCRIPTION OF THE DRAWINGS

FIG. 1 is a perspective view of a rotor according to an embodiment.

FIG. 2 is a cross-sectional view of the rotor shown in FIG. 1.

FIG. 3 is a cross-sectional view of a plastic filling device according to the embodiment.

FIG. 4 is a cross-sectional view of the plastic filling device in a state in which a rotor core is clamped.

FIG. 5 is a cross-sectional view illustrating a state in which insertion holes of the rotor core are filled with plastic.

FIG. 6 is a flowchart showing a procedure of a clamping step executed by a controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

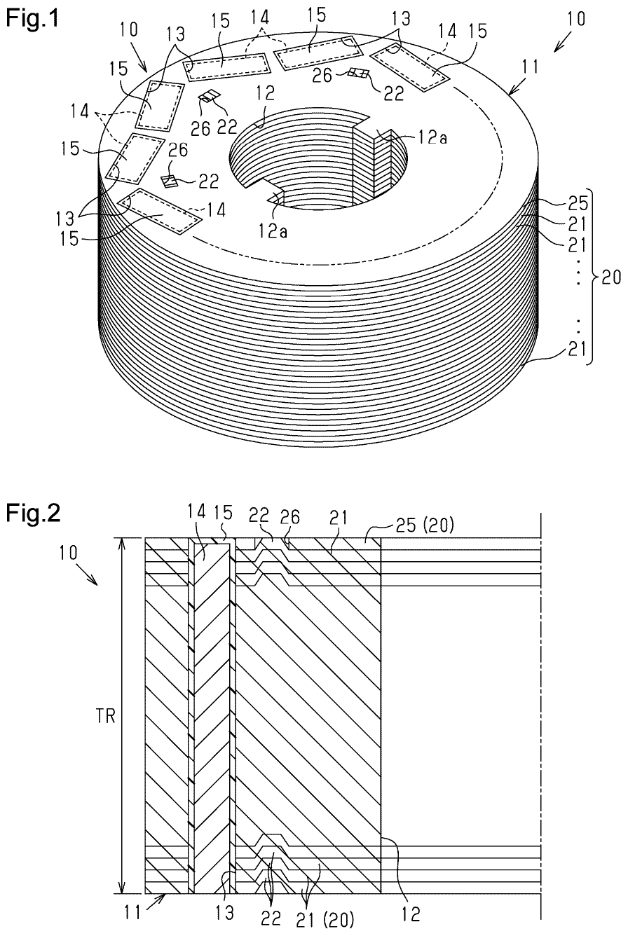

A method for manufacturing a rotor according to one embodiment will now be described with reference to FIGS. 1 to 6.

### Rotor 10

First, a rotor 10 used in a magnet-embedded motor will be described with reference to FIGS. 1 and 2.

The rotor 10 includes a rotor core 11, which includes insertion holes 13, magnets 14, which are inserted into the insertion holes 13, and a plastic 15. The plastic 15 is a thermoplastic filling the insertion holes 13 to fix the magnets 14 to the rotor core 11.

The rotor core 11 is substantially cylindrical and includes a center hole 12. The rotor core 11 is formed by a stacked body in which iron core pieces 20 made of magnetic steel sheets are stacked.

In the following description, the stacking direction of the rotor core 11 will simply be referred to as a stacking direction, radial directions of the rotor core 11 will simply be referred to as radial directions, and a circumferential direction of the rotor core 11 will simply be referred to as a circumferential direction.

The insertion holes 13 are arranged at intervals in the circumferential direction. In the present embodiment, the insertion holes 13 are schematically depicted to have a substantially rectangular cross-sectional shape.

The center hole 12 and the insertion holes 13 extend through the rotor core 11 in the stacking direction.

As shown in FIG. 1, two key portions 12a are provided on the inner circumferential surface of the center hole 12 to be opposed to each other in the radial direction.

### Iron Core Pieces 20

As shown in FIGS. 1 and 2, the iron core pieces 20 include first iron core pieces 21, which are stacked successively, and a second iron core piece 25, which is stacked on one side of the first iron core pieces 21 (upper side as viewed in FIGS. 1 and 2).

As shown in FIG. 2, each first iron core piece 21 includes tabs 22 that bulge toward the second iron core piece 25 in the stacking direction. The tabs 22 are arranged at intervals in the circumferential direction (refer to FIG. 1). Any two of the first iron core pieces 21 adjacent to each other in the stacking direction are coupled to each other by press-fitting the tabs 22 to each other.

The second iron core piece 25 includes through-holes 26, into which the tabs 22 of the first iron core piece 21 adjacent to the second iron core piece 25 are fitted. The through-holes 26 are spaced apart from each other in the circumferential direction and arranged at positions overlapping with the tabs 22 in the stacking direction.

### Plastic Filling Device 30

A plastic filling device 30 will now be described.

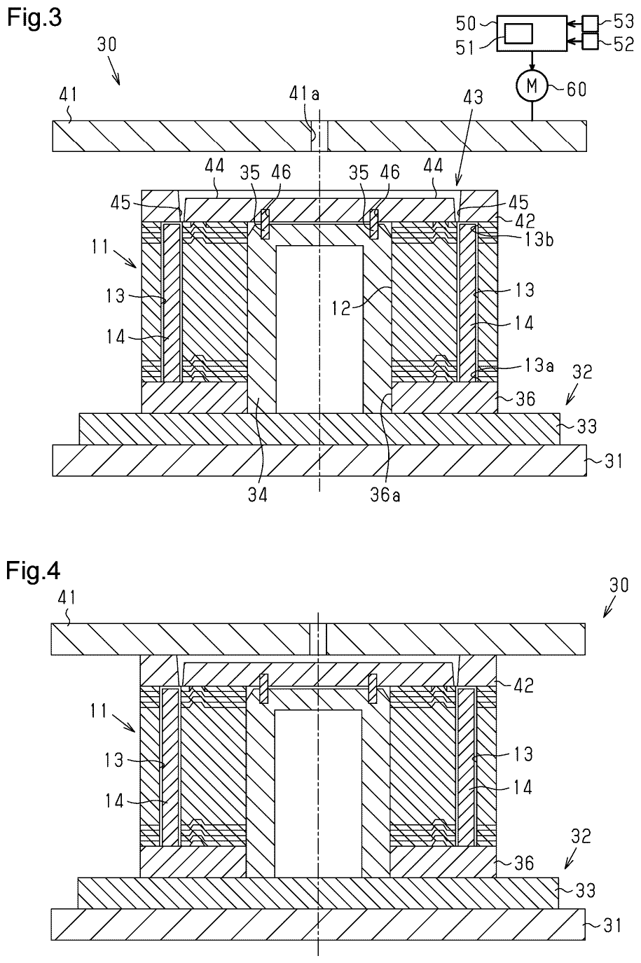

As shown in FIG. 3, the plastic filling device 30 includes a lower die 31, a conveying plate 32, a first plate 36, an upper die 41, a second plate 42, and a controller 50.

### Lower Die 31 and Upper Die 41

As shown in FIG. 3, the lower die 31 is a fixed die.

The upper die 41 is a movable die and is configured to be moved vertically above the lower die 31. The upper die 41 includes a sprue passage 41a, which is connected to a nozzle (not shown) of an injection molding machine (not shown).

A motor 60 is coupled to the upper die 41. The upper die 41 is moved vertically by the driving force of the motor 60.

### Conveying Plate 32

As shown in FIG. 3, the conveying plate 32 conveys the rotor core 11 and is arranged on the upper surface of the lower die 31.

The conveying plate 32 includes a substantially square plate body 33 and a substantially cylindrical post portion 34.

The post portion 34 projects upward from the central part of the plate body 33. The post portion 34 is inserted into the center hole 12 of the rotor core 11. The post portion 34 includes two keyways (not shown), which extend in the axial direction of the post portion 34, on the outer circumferential surface. The position in the circumferential direction of the rotor core 11 with respect to the plate body 33 is determined by inserting the key portions 12a of the rotor core 11 into the keyways.

Engaging pins 35 projecting upward are provided at the upper end of the post portion 34.

### First Plate 36

As shown in FIG. 3, the first plate 36 is disposed on the upper surface of the plate body 33.

The first plate 36 has a through-hole 36a, through which the post portion 34 is inserted. Two restricting projections (not shown) are provided on the inner circumferential surface of the through-hole 36a. The restricting projections are inserted into the two keyways of the post portion 34 to position the first plate 36 in relation to the plate body 33.

The lower surface of the rotor core 11 contacts the upper surface of the first plate 36 to close lower openings 13a of the insertion holes 13.

### Second Plate 42

As shown in FIG. 3, the second plate 42 contacts the upper surface of the rotor core 11 to close upper openings 13b of the insertion holes 13.

The second plate 42 includes a passage 43 that supplies the plastic 15 to the upper openings 13b.

The passage 43 includes branch passages 44 and gate passages 45. The branch passages 44 are connected to the sprue passage 41a and extend radially outward in the radial direction. The gate passages 45 extend in the vertical direction from radially outer ends of the branch passages 44 toward the lower surface of the second plate 42. The gate passages 45 are provided to correspond to the respective insertion holes 13.

The second plate 42 has engaging holes 46 in the lower surface. The engaging holes 46 are engaged with the engaging pins 35. The engaging holes 46 are respectively located at positions corresponding to the engaging pins 35.

### Controller 50

The controller 50 is configured to control operation of the motor 60 and is electrically connected to the motor 60.

The controller 50 is electrically connected to a current sensor 52, which detects a current value IM flowing through the motor 60, and a rotation angle sensor 53, which detects a rotation angle θ of the output shaft of the motor 60.

The controller 50 may be control circuitry including: 1) one or more processors that operate according to a computer program (software); 2) one or more dedicated hardware circuits (application specific integrated circuits: ASIC) that execute at least part of various processes; or 3) a combination thereof. The processor includes a CPU and memories such as a RAM and a ROM. The memories store program codes or commands configured to cause the CPU to execute processes. The memories, or computer-readable media, include any type of media that are accessible by general-purpose computers and dedicated computers. The controller 50 includes a memory 51, which stores a clamping position of the upper die 41.

The controller 50 acquires the position of the upper die 41 in the vertical direction, relative to the clamping position as the origin, based on the clamping position and the rotation angle θ of the output shaft of the motor 60, and controls the operation of the motor 60 to change the position of the upper die 41 in the vertical direction.

The controller 50 performs clamping by lowering the upper die 41 to the clamping position stored in the memory 51.

When a rotor core 11 of a type different from the rotor core 11 clamped immediately prior is clamped for the first time, the controller 50 detects whether the rotor core 11 is in a clamped state. Upon detecting that the rotor core 11 is in a clamped state, the controller 50 stores the position of the upper die 41 in the vertical direction at that time as the new clamping position in the memory 51, and controls the motor 60 to stop the descent of the upper die 41.

In the present embodiment, the controller 50 determines whether the rotor core 11 is clamped by the upper die 41 and the lower die 31 based on the current IM detected by the current sensor 52.

### Method for Manufacturing Rotor 10

As shown in FIGS. 2 to 5, the method for manufacturing the rotor 10 includes a thickness control step, a placement step, a clamping step, and a filling step.

### Thickness Control Step

As shown in FIG. 2, in the thickness control step, a specified load is applied to the rotor core 11 in the stacking direction by a press-fitting device (not shown). Accordingly, the tabs 22 of the first iron core pieces 21 are press-fitted to each other. Also, the tabs 22 of the uppermost first iron core piece 21 are press-fitted into the through-holes 26 of the second iron core piece 25. A thickness TR of the rotor core 11 in the stacking direction is thus controlled. At this time, the thickness TR of the rotor core 11 is controlled such that the thickness of the rotor core 11 is in a specified range set for each type of rotor core 11. In the thickness control step, a rotor core 11 that has a thickness TR outside the specified range set for each type of rotor core 11 is determined to be defective and removed from the manufacturing line.

### Placement Step

As shown in FIG. 3, in the placement step, the rotor core 11 after the thickness control step is placed on the upper surface of the conveying plate 32. Then, the magnets 14 are inserted into the insertion holes 13. Subsequently, the second plate 42 is mounted on the upper surface of the rotor core 11. The rotor core 11, on which the second plate 42 is placed, is placed on the lower die 31 together with the conveying plate 32.

### Clamping Step

As shown in FIG. 4, in the clamping step, the controller 50 lowers the upper die 41 to the clamping position stored in the memory 51, thereby performing clamping.

### Filling Step

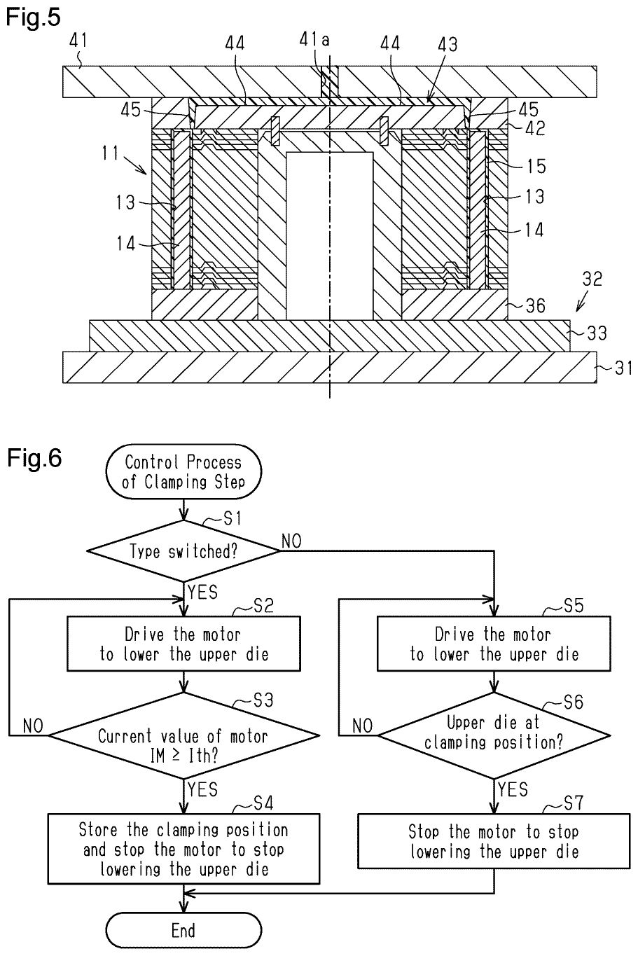

In the filling step, as shown in FIG. 5, the insertion holes 13 are filled with the plastic 15 in a state in which the rotor core 11 is clamped by the upper die 41 and the lower die 31. Specifically, when the plastic 15 in a molten state is supplied to each branch passage 44 from the sprue passage 41a of the upper die 41, the insertion holes 13 are filled with the plastic 15 through the gate passages 45.

Subsequently, the plastic 15 is cooled so that the magnets 14 are fixed to the rotor core 11.

### Procedure of the Clamping Step

Next, the procedure of a control process of the controller 50 during the clamping step will be described with reference to the flowchart shown in FIG. 6.

This series of processes is executed by the controller 50 each time a rotor core 11 is placed on the lower die 31 in the placement step.

First, the controller 50 determines whether the type of the rotor core 11 has been switched (step S1). Specifically, based on signals input to the controller 50, the controller 50 determines whether the rotor core 11 placed on the lower die 31 is of a type different from the rotor core 11 that was clamped immediately prior.

When determining that the type of the rotor core 11 has been switched (step S1: YES), the controller 50 drives the motor 60 to lower the upper die 41 (step S2). Next, the controller 50 determines whether the current value IM of the motor 60 is greater than or equal to a threshold Ith (step S3).

If it is determined that the current value IM is not greater than or equal to the threshold Ith (step S3: NO), steps S2 and S3 are repeatedly executed until the current value IM is greater than or equal to the threshold Ith.

When determining that the current value IM is greater than or equal to the threshold Ith (step S3: YES), the controller 50 stores, as the clamping position, the position of the upper die 41 at that time in the memory 51, and stops the motor 60 to stop lowering the upper die 41 (step S4).

The controller 50 then ends this series of processes.

When determining that the type of the rotor core 11 has not been switched (step S1: NO), the controller 50 drives the motor 60 to lower the upper die 41 (step S5). Next, the controller 50 determines whether the position of the upper die 41 is the clamping position (step S6).

If it is determined that the position of the upper die 41 is not the clamping position (step S6: NO), steps S5 and S6 are repeated until the position of the upper die 41 is the clamping position.

If it is determined that the position of the upper die 41 is the clamping position (step S6: YES), the controller 50 stops the motor 60 to stop lowering of the upper die 41 (step S7).

The controller 50 then ends this series of processes.

### Operation of Present Embodiment

As shown in FIG. 6, when a rotor core 11 of a type different from the rotor core 11 clamped immediately prior is clamped for the first time, whether the rotor core 11 of the different type is clamped is detected. When detecting that the rotor core 11 is in a clamped state, the position of the upper die 41 in the vertical direction is stored in the memory 51 as the clamping position, and the controller 50 stops lowering the upper die 41. In the thickness control step, which is prior to the clamping step, the thickness TR of the rotor core 11 is controlled to be in a specified range set for each type of rotor core 11. Thus, since the detection of the clamping state and the storage of the clamping position are performed by using the rotor core 11, which is formed with high dimensional accuracy required for a product, the clamping position is accurately changed without using a master workpiece. Therefore, when the second and subsequent rotor cores 11 after the type switching are clamped, the clamping is performed by a simple control method of lowering the upper die 41 to the clamping position stored in the memory 51 through the controller 50.

### Advantages of Present Embodiment

(1) In the clamping step, when a rotor core 11 of a type different from the rotor core 11 clamped immediately prior is clamped for the first time, the controller 50 detects whether the rotor core 11 of the different type is clamped. Further, the controller 50 stores, as the clamping position, the position of the upper die 41 in the vertical direction at the time when the clamped state is detected in the memory 51, and stops lowering the upper die 41.

This method, which operates in the above-described manner, facilitates the steps for manufacturing the rotor 10.
(2) The controller 50 detects that the rotor core 11 is in a clamped state when the current value IM through the motor 60 for driving the upper die 41 is greater than or equal to the threshold Ith.

The method allows the controller 50 to detect that the rotor core 11 is in a clamped state by using conventional configurations. Therefore, it is possible to easily implement a configuration for detecting that the rotor core 11 is in a clamped state.

### MODIFICATIONS

The above-described embodiment may be modified as follows. The above-described embodiment and the following modifications can be combined as long as the combined modifications remain technically consistent with each other.

In the above-described embodiment, whether the rotor core 11 is in the clamped state is detected by comparing the current value IM through the motor 60, which drives the upper die 41, with the threshold Ith. However, the present disclosure is not limited thereto. For example, images of the rotor core 11 and the upper die 41 may be captured by a camera, and the captured images may be processed to detect whether the rotor core 11 is in a clamped state.

In the above-described embodiment, the plastic filling device 30 is used to fill the insertion holes 13 with the plastic 15, which is thermoplastic. However, a plastic filling device may be used that fills the insertion holes 13 with thermosetting plastic.

In the above-described embodiment, the upper die 41 is used as a movable die, and the lower die 31 is used as a fixed die. Instead, the upper die 41 may be used as a fixed die, and the lower die 31 may be used as a movable die.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rotor, the rotor including a rotor core, a magnet, and a plastic, the rotor core being formed by stacking multiple iron core pieces and including an insertion hole extending in a stacking direction of the iron core pieces, the magnet being inserted into the insertion hole, and the plastic filling the insertion hole to fix the magnet, the method comprising:
controlling a thickness of the rotor core such that the thickness of the rotor core is in a specified range that is set for each type of the rotor core;
after the controlling the thickness of the rotor core, placing the rotor core on a fixed die or a movable die of a plastic filling device with the magnet inserted into the insertion hole, the movable die being configured to be moved vertically; and
clamping the rotor core by moving the movable die vertically to a clamping position stored in a memory of control circuitry; and
filling the insertion hole with the plastic in a state in which the rotor core is clamped by the fixed die and the movable die,
wherein the clamping the rotor core includes:
when clamping, for a first time, a rotor core of a type different from a rotor core clamped immediately prior, detecting whether the rotor core of the different type is in a clamped state;
storing, in the memory, a position of the movable die in the vertical direction at the time when the rotor core is detected to be in the clamped state as the clamping position; and
stopping the vertical movement of the movable die.

2. The method for manufacturing the rotor according to claim 1, wherein the clamping the rotor core includes detecting, when the rotor core of the type different from the rotor core clamped immediately prior is clamped for the first time, that the rotor is in the clamped state if a current value of a motor that drives the movable die is greater than or equal to a threshold.
